(19) United States
(12) Patent Application Publication
(10) Pub. No.: US 2020/0051147 A1
(43) Pub. Date: Feb. 13, 2020

(54) Deriving and Presenting Real Time Marketable Content by Efficiently Deciphering Complex Data of Large Dynamic E-Commerce Catalogs

(71) Applicant: Digital River, Inc., Minnetonka, MN (US)

(72) Inventors: Billy Chi Hsun Tsai, Taipei City (TW); Ming-Wei Yang, Taipei City (TW); Ping-Tai Teng Teng, New Taipei City (TW); Yung-Fu Tsai, New Taipei City (TW)

(73) Assignee: Digital River, Inc., Minnetonka, MN (US)

(21) Appl. No.: 16/100,905

(22) Filed: Aug. 10, 2018

(51) Int. Cl. G06Q 30/06; G06Q 30/02

(52) U.S. Cl. CPC G06Q 30/0603; G06Q 30/0222; G06Q 30/0283; G06Q 30/0625

(57) ABSTRACT

Systems and methods are disclosed for the functional decomposition of the catalog domain and its sub-domains inside a global scale e-commerce system into respective software application services with dedicated data storage, so in order for the complex raw data of different nature or sub-domain that belongs to large catalogs to be easily accessed and read by online stores, it needs to be deciphered and derived by its domain specific computational process then materialized into appropriate real time content that can be directly obtained via software services and APIs by B2C and B2B websites instead having to utilize lots of computational power for every on line store page request to generate necessary real time content from the same raw catalog data that is administered by catalog managers. In the case of data that does not frequently change (i.e. static data), the query or search conditions to retrieve such data are not many and most of the queries and searches are the same, then that data can be deciphered in advance and the corresponding content can be derived, materialized and stored in a manner for fast look up. As for data that frequently changes (i.e. dynamic data) or have many query or search conditions, in order to decipher vast amount of raw data to derive the correct meaningful data that is applicable to shoppers visiting website real time, a distributed computational engine that is capable of large-scale data processing which can effectively utilize hardware resources (i.e. CPU and memory) fully is used to in this situation.

### FIELD OF THE INVENTION

The present invention relates generally to the real time presentation of accurate and meaningful content from the raw complex data of large dynamic e-commerce catalogs on B2C and B2B websites, such as products in various permutations with original price and discounted prices, and promotional offers for individual customers or all customers visiting the site. In order for the complex raw data from different sources or origin to be consumed then identified with its nature or sub-domain that it belongs inside large catalogs so it can be subsequently easily accessed and read by online stores. More specifically, the present disclosure relates to systems and methods for deriving catalog content by deciphering large amount of complex catalog data and managing the content for presentation and selection on one or more e-commerce websites.

### BACKGROUND OF THE INVENTION

In a traditional e-commerce system that is comprised of a number of software applications and databases, the domain and data models that represent the catalog business entities (e.g. products, prices, merchandising offers and promotions) usually have been designed so the respective features and functionality can be quickly developed and their data can be easily edited and managed. For those same reasons the data set elements and entities are not only updated by administrative commands but also requested (searches and queries) by online storefront functions for real time content generation. The data mentioned herein can be created by the same ecommerce system or imported from other external third-party systems. Within the large amounts of data to be imported, duplicate data must be detected so unnecessary rewrites or updates don't occur, contributing a large overhead to the systems.

In order for the catalog data to be more administrable, some of it is stored in a highly normalized fashion and some of it is semi-structured or unstructured. Due to these different storage solutions, catalog data is difficult to query or extract directly and requires utilization of some amount of application and database servers' computation power to generate the latest accurate content to be displayed by the B2C and B2B sites, especially as the number of read operations performed by those sites may be magnitudes greater than the number of write operations performed by the administrative interfaces. Also, some origins or sources of data are not created by the same ecommerce system. They can be from third party sources or different external systems so such data is initially in different format and structure and needs to be imported efficiently so it can be administrable. The catalogs with their products and corresponding prices created by the same ecommerce system need to be exported in different formats for other parties to consume.

Additionally, due to many create and update operations performed by administrative functions against the same sets of data objects, different corresponding auditing mechanisms maybe needed for each set for tracking how the data's final state and values came about. Traditional means of accessing writing, updating and transmitting data in a large software system are not reliable, scalable, or performant and are time intensive, because of the additional heavy computations required or inefficient computational methods performed by the software in real time.

Therefore, in the embodiment of this present invention, new systems and methods are developed to segregate operations that retrieve data from operations that update data, the data that is to be retrieved by the shopper sites is reformatted, stored in a different storage solution and accessed differently in order to maximize performance of the large number of read and analytic operations which include automatic selection of specialized content generation, distribution and publication mechanisms with comprehensive audit trails for reliability assurance depending on the applicable use cases and the nature of the data.

Since new processes are used to access catalog content, the scalability of the ecommerce system is increased when the online storefronts are being visited by many shoppers. Traditional means of accessing, writing, updating, importing and transmitting data in a large software system are not scalable, not performant and are time intensive, because of the additional heavy computations required to be performed or inefficient computational methods performed by the software at real time. This disclosure provides a solution and offers other advantages over the prior art.

### SUMMARY

The embodiments presented herein are directed to systems, methods and computer program products for transforming e-commerce catalog content to be displayed on webstores easily and quickly, especially for B2C sites that experience a large number of shoppers browsing the catalog content. Such content can be obtained by those sites and presented to shoppers with an excellent user experience and more efficient use of computing resources, even during peak traffic periods when special merchandising offers are made on those sites, which may lead to many more shoppers browsing the catalog content and ordering products. The resulting increased scalability offered by the system and methods provides excellent user experience and enhanced order fulfillment. The embodiments provide scalability by decoupling the data model of each catalog subdomain from the central catalog database into a domain specific data engine for the exportation and importation of recent and relevant data. The domain specific data engine is comprised of dedicated data storage with dedicated software applications as will be described below.

In accordance with one exemplary embodiment, a computer implemented method is disclosed for generating product data such that catalog product attributes and meta data are converted to a format that conforms to a flat structure, so the data can be directly transferred via web services over the Internet and be easily interpreted by websites for presentation to shoppers.

In accordance with one exemplary embodiment, a system is disclosed for deciphering the complex product data that is stored in a hierarchical structure then generate a copy of the same data in a flat structure that is subsequently stored in a search engine which is highly performant, scalable, interoperable and provides very powerful querying and searching capabilities as web services. The e-commerce websites can directly utilize the web services provided by that search engine to retrieve products with their data in an easily readable and interpretable format.

In accordance with one exemplary embodiment, a computer implemented method is disclosed for supporting complex product searches performed by the e-commerce system's administrative console, the product data is copied from the e-commerce system's database (where the product data is stored in the same hierarchical structure mentioned herein) then written into a dedicated search engine of the same type with the same manner mentioned herein, the administrative console is able to search products by various different attributes by utilizing the web services provided by that search engine.

In accordance with one exemplary embodiment, a computer implemented method is disclosed for generating product price data such as the list price in various currencies of different locales (i.e. countries and languages) in a format that conforms to flat structure, so all that data can be directly transferred via web services over the Internet and easily interpreted by websites for presentation to shoppers.

In accordance with one exemplary embodiment, a system is disclosed for deciphering the complex price lists with their prices that are stored in a hierarchical structure then generate a copy of the same data in a flat structure that is subsequently stored in the same search engine for storing products with their data and provides the querying and searching capabilities as web services for product prices that don't often change and are constantly and frequently looked up by the same criteria. The e-commerce websites can directly utilize the web services provided by that search engine to retrieve product prices in an easily readable and interpretable format.

In accordance with one exemplary embodiment, a computer implemented method is disclosed for arbitrating quickly among many merchandising offers on an e-commerce website, then deciding the best offer that is to be applied to a shopper based on many various dynamic conditions. This method includes generating offers in a format that conforms to a flat structure, so all that data can be easily and quickly arbitrated then the result can be transferred via web services over the Internet to websites as the offer to be applied to shoppers.

In accordance with one exemplary embodiment, a system is disclosed for deciphering the merchandising offers with their discount settings that are stored in a hierarchical structure then generate a copy of the snapshots of same data in a flat structure that is subsequently stored in a NoSQL database (where the data model is a partitioned row store with tunable consistency, rows are organized into tables, the first component of a table's primary key is the partition key, within a partition, and rows are clustered by the remaining columns of the key, other columns may be indexed separately from the primary key, tables may be created, dropped, and altered at runtime without blocking updates and queries). This system includes a high velocity and high-volume computational engine for large scale data processing, so arbitrations are performed by this engine to determine what is the best offer out of large number of offers stored in the NoSQL database mentioned herein based on the many dynamic conditions given at request time. The arbitration result is then provided via a web service to e-commerce websites as the best discount of products on those sites.

In accordance with one exemplary embodiment, a computer implemented method is disclosed for the aggregation of the result from each individual web service for e-commerce websites described herein, that method is performed by a service application as the catalog domain's aggregation service so the web application that hosts those websites only needs to invoke one single catalog domain application centric web service that returns a response payload which includes all the product data (i.e. attributes), and pricing information (i.e. original price and discounted price), rather than making three separate web service invocations, one to product data service, one to product price service and one to product discount service, this way avoids incurring additional network latencies that affect performance.

Before explaining exemplary embodiments of the present invention disclosure, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as in the abstract, are for the purpose of description and should not be regarded as limiting.

The accompanying drawings, which are incorporated in and constitute a part of this specification, illustrate certain embodiments of the disclosure, and together with the description, serve to explain the principles of the disclosure. As such, those skilled in the art will appreciate that the conception upon which this disclosure is based may readily be utilized as a basis for designing other structures, methods, and systems for carrying out the several purposes of the present disclosure. It is important, therefore, to recognize that the claims should be regarded as including such equivalent constructions insofar as they do not depart from the spirit and scope of the present disclosure.

### BRIEF DESCRIPTION OF THE DRAWINGS

FIG. 1 illustrates various software applications and data storages with their data flows for practicing embodiments consistent with the present disclosure;

FIG. 2 illustrates how an e-commerce system's catalogs with the relevant products can be exported from one data storage that is used by an administrative console and a bulk tool or external system modules, then imported into another data storage that is used by shopper facing websites;

FIG. 3 illustrates how an e-commerce system's administrative console can search for complex products and complex product variations;

FIG. 4 illustrates how product prices can be exported from one data storage that is used by an administrative console and a bulk tool then imported into another data storage that is used by shopper facing websites;

FIG. 5 is an extension of FIG. 4 illustrating the upload of bulk catalog data in a utility tier and an exemplary data processing system for pre-calculation of static prices that are to be stored into a pricing domain data storage that is used by shopper facing websites;

FIG. 6 is a further extension of FIG. 5 illustrating the provision of accurate catalog information to a shopper browsing a webstore; the figure illustrates how snapshots of merchandising offers can be exported from one data storage that is used by an administrative console and a bulk tool then imported into another data storage that is used a high velocity and high volume computational engine for large scale data processing, the output of that engine is then served by a web service that is to be used by shopper facing websites;

FIG. 7 illustrates the software applications that make up the high velocity and high-volume computational engine for large scale data processing of pricing complex pricing data;

FIG. 8 illustrates the admin tier of a merchandising administration service;

FIG. 9 is an extension of FIG. 8 illustrating the display of catalog shopping services with a real time pricing arbitration service to offer the online shopper the most current and accurate price for a product;

FIG. 10 illustrates the physical and software components of the pricing arbitration engine;

FIG. 11 illustrates the multi-tier system and interactions among components providing catalog services to online shoppers.

### DETAILED DESCRIPTION

A traditional e-commerce system is normally comprised of software applications with a monolithic architecture, multiple relational databases, application programming interfaces (APIs), several message brokers and some external services. Such a system presents several challenges with precise derivation of correct content and information from a traditional database management system.

In a traditional e-commerce system, huge volumes of raw data have been created by administrative functionalities. Out of those volumes, it is necessary to provide data truly required by the storefronts quickly, painlessly and at scale. Data may be provided quickly if the data is 100% precomputed (pre-calculated) before providing the requests, but that is inflexible and wastes resources. However, if the data required is a real-time dynamic calculation (arbitration), then the data presented should be computed results from raw data whenever it is requested. This is more flexible, but slow to return a response.

In one embodiment of the present invention, this problem is solved by a system and method that provide a way to pre-aggregate the most common queries and easily generate many materialized view (i.e. in memory cache and read only static data), flexible and fast dynamic queries and use clustering computing engines for fast random row access and fast distributed computations for providing data.

Further, the embodiment of our current invention divides suitable data to pre-calculate static prices, not suitable data to pre-arbitrate offer instances, and not suitable nor necessary data to calculate prices in real time.

### Definition of Terms

The following terms take the meanings explicitly associated herein, unless the context clearly dictates otherwise.

The term “data elements” is interchangeable with “entities” or “data records” and refers to the data recorded in memory or other storage devices.

Marketable Content: Storefront content with interesting product details accompanied by special pricing and merchandising offers that attract shoppers to purchase products.

Complex Data: Data that is represented in various formats (database, texts, images), diversely structured (relational database, XML and HTML documents), originated from several different sources and multi-version (changing in terms of definition or value).

Large Dynamic E-Commerce Catalog: A catalog that contains a very large number (tens of thousands to hundreds of thousands) of distinct sellable products that have complex data that are frequently updated by various sources.

Domain Model: A model that describes real world entities and the relationships between them, which collectively describe the problem domain space.

Data Model: A model that organizes data elements and standardizes how the data elements relate to one another. Since data elements document real life people, places and things and the events between them, the data model represents reality.

Business Entity: Key business relevant dynamic conceptual objects that are created, evolved, and (typically) archived as they pass through the operations of an enterprise/organization. A Business Entity includes both an information model for data about the business objects during their lifetime, and a lifecycle model, which describes the possible ways and timings that tasks can be invoked and performed on these objects.

Monolithic Architecture: A single-tiered software application with a structure that contains presentation and user interface components, business logic and rules, database access logic, integration logic (web services and messaging layer) in a manner which functionally distinguishable aspects are not architecturally separate components but are all interwoven.

Application Tier: Physical allocation of multiple copies of application that has monolithic architecture on multiple machines.

Database Tier: Physical allocation of multiple database servers that stores an application's data and which database servers are accessed by the application.

Integration Tier: Software servers that route data between applications synchronously and asynchronously.

Message Queue: Software servers that enable applications running at different times to communicate across heterogeneous networks and systems that may be temporarily offline. Applications send messages to queues and read messages from queues. Messages are placed onto the server and are stored until the recipient retrieves them. Those servers have implicit or explicit limits on the size of data that may be transmitted in a single message and the number of messages that may remain outstanding on the servers.

BPU: Bulk Product/Price Upload->A.K.A Bulk Tool or Bulk Loader is a software utility functionality that is capable of importing large amounts of catalog data into the e-commerce system's database. The sources of the data can be either one or more Excel spreadsheets or XML documents. The BPU may export large amounts of catalog data out of the e-commerce system's database into either an Excel spreadsheet or an XML document. The catalog data can be products with their attributes and value(s), products with their prices, price lists, and merchandising offers.

Enterprise System (ES): An e-commerce platform built from the ground up as an on-demand platform to support the global sales and marketing needs of digital and physical goods sellers. It may be an incredibly deep platform, covering the complete spectrum of services needed to run a high-scale, global e-commerce business. Consistent with the embodiments described herein, it has product catalog management, merchandising and pricing features.

Enterprise System Commerce Console (ESCC): An ESCC is a platform (ES) with a user interface providing a user with complete control of products, catalogs, content and pricing via an intuitive web-based toolset. This toolset is available 24×7×365 for users with role-based permissions. An ESCC has the ability to create, update and retire products, catalogs, categories, pricing and product variations (multi-nested product configurations) along with spreadsheet-based bulk updates. Every control is powerful and yet easy-to-use to make catalog management tasks simple for the business-level user.

Static Price: When displaying a product price in product details page, product category page or search result page on a storefront, all prices on the price list are queried, then computation is performed to determine which price's attributes match the storefront attributes (e.g. currency, locale, catalog). Those prices are rarely changed, so the performance of the storefront may lag if it needs to load a list of product prices because of real-time computation. It's even worse when a storefront needs to sort product by price and do pagination, since a large number of price computations are performed. Since the prices on the price lists don't have too many attributes, the price list prices can be stored in a manner with those attributes as look up keys, so if the storefront attributes match those keys, then the correct product price is directly obtained without performing any calculation or computation.

Offer Instance: A business object that contains the details of a specific merchandising offer that is applicable to only one, many or all shoppers on a specific storefront.

Event: Represents an activity or action with details such as who did it, what was done, where was it done, when was it done, why was it done (optional), and how was it done.

Event Store: A database or file storage that stores a series of immutable events.

Aggregator: A composer that combine and transform the data returned by multiple services or APIs into one single meaningful data set.

Choreographer: A form or method of service composition in which the interaction protocol between several partner services is defined from a global perspective, basically the coordinated interactions between multiple parties/services. A choreographer is a way of specifying how two or more parties—none of which has any control over the other parties' processes, or perhaps any visibility of those processes—can coordinate their activities and processes to share information and value.

Orchestrator: Describes what an overall process appears to do without specifying how any of it is implemented, basically the automated execution of a workflow or business process.

ES ODS: Enterprise System Operational Data Store—the database that is central source of truth of all catalog data, the database is used by administrative applications such as ESCC and BPU to create and update catalog data.

ES OT: Enterprise System Order Taker—the database that is only used by the storefront application on shopper nodes to create and update transactional data such as requisitions (i.e. orders). This database also has a copy of the catalog data in ES ODS.

Dispatch: An API gateway that provides routing, circuiting breaking, rate limiting, caching, authentication, throttling capabilities for all intranet and internet API traffic.

Display Manager: A presentation tier for rendering technology for client sites and an UI that allows clients to configure the look and feel of their site without major development effort.

Storefront: The shopper-facing pages of B2C or B2B sites that display products with their original and discounted prices, merchandising offers and promotional content. These pages are usually the home page, product details page, category page, interstitial page and shopping cart page.

Microservice: Software applications as independent, deployable, fine-grained services that are easily modifiable, interoperable, testable and scalable.

Coarse Grained Service: A software service that exposes the invocation of a single, discrete business process or workflow.

Transparent Commerce: The existing integration services that are provided by the monolithic ES application, the implementations are written inside the legacy ES codebase.

An enterprise e-commerce system provides many technical challenges at every architectural level, many of which are captured in Table 1. The system, methods and computer program products disclosed herein

TABLE 1
Problem-Solution Features

| Context | Problem | Solution |
|---|---|---|
| Application | Both commands (updates to the data) and | Command and Query Responsibility Segregation |
| Tier | queries (requests for data) are executed against | (CQRS) Pattern: Segregate operations that read |
| | the same set of entities in a single data | data from operations that update data by using |
| | repository (there is also a mismatch between | separate interfaces/APIs to maximize performance, |
| | the read and write representations of the data). | scalability, flexibility and security; prevent update |
| | Those entities may be a subset of the rows in | commands from causing merge conflicts at the |
| | one or more tables in a relational database. For | domain level. |
| | the same data to become meaningful additional | |
| | interpretations are required to be conducted by | |
| | the read operations which represent | |
| | computational overheads. | |
| Application | Each application operation has a | Composite Application: A software architecture |
| Tier | specific business or functional purpose that | pattern that incorporates different methods of |
| | read or obtain data with a specific method, | combining the execution/invocation of two or more |
| | however to conduct a more meaningful | non-sequential, inter-dependent or independent |
| | business process or workflow in order to | operations together either through orchestration or |
| | achieve certain business result(s), different | choreography then aggregates different pieces of |
| | operations need to be grouped then managed | data to provide a meaningful business outcome. |
| | together as a set of operations and the execution | |
| | of those operations needs to be coordinated. | |
| Database | When a query must be very complex in order to | Materialized View Pattern: Generate prepopulated |
| Tier | extract data that is stored in a normalized, semi- | views over the data in one or more data stores (e.g. |
| | structured, or unstructured way. Or requires | database tables) when the original data is formatted |
| | only a subset of the data from some entities, it | in a way that does not favor the required query |
| | must extract all of the data for the relevant | operations. To support efficient querying and data |
| | entities in order to obtain the required | extraction and improve application performance. |
| | information. Also, the number of read | |
| | operations is usually orders of magnitude | |
| | greater that the number of write operations. | |
| | Insert and update of one data record or multiple | |
| | data records are usually contained with a | |
| | transaction, which hinders performance when | |
| | large number of updates against the same set of | |
| | data records are performed by different clients. | |
| Application | The typical approach of how such system | Event Sourcing Pattern: An append only store to |
| & Database | works with data is for the application to | record the full series of events that describe actions |
| Tiers | maintain the current state of the data by | taken on data in a domain, rather than storing just |
| | updating it as users work with the data. For | the current state, so that the store can be used to |
| | example, in the traditional create, read, update, | materialize the domain objects. Therefore, simplify |
| | and delete (CRUD) model a typical data | tasks in complex domains by avoiding the |
| | process will be to read data from the store, | requirement to synchronize the data model and the |
| | make some modifications to it, and update the | business domain; improve performance, scalability, |
| | current state of the data with the new values, | and responsiveness; provide consistency for |
| | often by using transactions that lock the data. | transactional data; and maintain full audit trails and |
| | Performance and responsiveness maybe | history that may enable compensating actions. |
| | hindered, with limited scalability, due to the | |
| | processing overhead the software application | |
| | requires. Also, in a collaborative domain with | |
| | many concurrent users, data update conflicts | |
| | are more likely to occur because the update | |
| | operations take place on a single item of data, | |
| | and an additional auditing mechanism is | |
| | required. | |
| Integration | When a large number of requests need to be | Competing Consumers Pattern: Enable multiple |
| Tier | handled if the software is to process each | concurrent consumers to process messages |
| | request synchronously when a sudden burst in | received on the same messaging channel, process |
| | user activity or aggregated requests coming | multiple messages concurrently to optimize |
| | from multiple tenants may cause unpredictable | throughput, to improve scalability and availability, |
| | workload, then the business logic in the | and to balance the workload. |
| | application can be blocked while the requests | |
| | are being processed. | |
| Integration | When a message queue is used to implement | Queue Based Load Leveling Pattern: Use a queue |
| Tier | the communication channel between the | that acts as a buffer between a task and a service |
| | software applications and multiple instances of | that it invokes in order to smooth intermittent |
| | the consumer service, the messaging system | heavy loads that may otherwise cause the service to |
| | may be overloaded by an influx of messages | fail or the task to time out, in order to minimize the |
| | coming from the applications, so the workload | impact of peaks in demand on availability and |
| | maybe fluctuated, therefore those instances of | responsiveness for both the task and the service. |
| | consumer must be coordinated to ensure that | |
| | each message is only delivered to a single | |
| | consumer. The workload also needs to be load | |
| | balanced across consumers to prevent an | |
| | instance from becoming a bottleneck. | |
| Application | Batch and real time operations are divided into | Compute Resource Consolidation Pattern: |
| Tier | discrete computational units that are hosted and | Consolidate multiple tasks or operations into a |
| | deployed individually. Each computational unit | single computational unit to increase compute |
| | consumes chargeable resources, even when it is | resource utilization and reduce the costs and |
| | idle or lightly used. Therefore, this approach | management overhead associated with performing |
| | may not always be the most cost-effective | compute processing. |
| | solution. | |
| | Mountains of raw data created and updated by | |
| | e-commerce store's functions to directly | |
| | provide the nuggets quickly, painlessly and at | |
| | scale. | |

Reference will now be made in detail to exemplary embodiments of the disclosure, examples of which are illustrated in the accompanying drawings. Wherever possible, the same reference numbers will be used throughout the drawings to refer to the same or like parts.

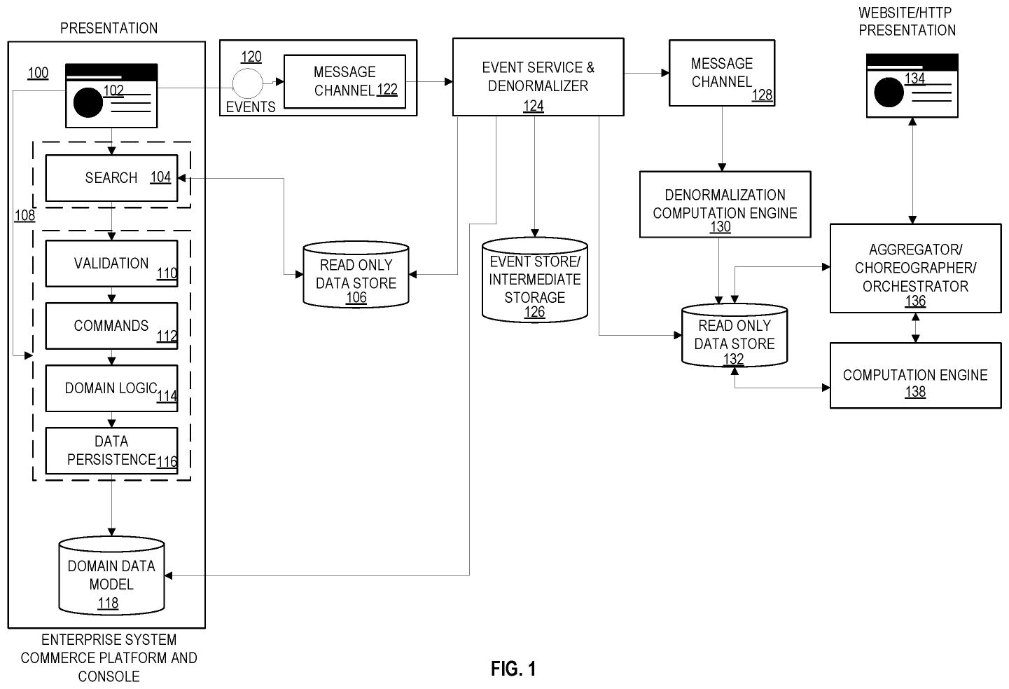

FIG. 1 illustrates an exemplary system environment that is consistent with the disclosed embodiments. Such an environment may be used to perform various functions and methods for identifying, extracting, transporting and presenting catalog content directly on B2C and B2B websites, consistent with the present disclosure. The methods or processes performed in or with the environment may improve shoppers' online experiences, increase the amount and quality of relevant online content, and/or maximize network web traffic and sales. An ESCC 100 can be abstractly depicted as an administrative tier as a software application with a presentation layer or user interface 102 with administrative screens and an integration layer with search capabilities 104 directed to a read-only data store 106. The ESCC further provides a business layer with updating capabilities that allow the user to maintain products, product attributes, pricing, merchandising offers, and more 108. The system may consist of various modules for facilitating the creation of records in a domain data model including a validation 110, command module to create and update) 112, a domain logic module 114 and a data persistence 116 module that persists data into the e-commerce system's central database 118 that is the source of truth for all catalogs. While the majority of references to catalog data sources are referred to herein as the “ESCC” or the “BPU,” catalog data sources can include third-party systems as well. Third party data may require additional pre-processing prior to being consumed and processed by the systems and methods described herein.

The ESCC sends event messages 120 to a high-throughput distributed messaging system 122 with several message channels, or queues (e.g. create product event, update product price event, retire product event) that allow applications running at different times to communicate across heterogeneous networks. Messages are placed onto the message system server and are stored until the recipient system retrieves them. There are implicit and explicit limits on the size of data that may be transmitted in a single message and the number of messages that may remain outstanding on the server.

An event service and denormalizer 124 receives all the events from the administrative console application and stores them with relevant data in an event store 126. The data model of the event store 126 is a partitioned row store with tunable consistency. Rows are organized into tables with the first component of a table's primary key being the partition key Within a partition, rows are clustered by the remaining columns of the key, other columns may be indexed separately from the primary key, and tables may be created, dropped, and altered at runtime without blocking updates and queries.

The service application 124 in turn exports the latest effected catalog data that corresponds to those events from the central database 118. As the exported data is originally structured to be stored in a very complex schema (i.e. normalized data model), it is processed by a denormalizer 124 to become simple data with flat structure and without schema (i.e. denormalized data model), then imported into two types of read only data stores. One 106 is located within close network proximity to the admin tier 100 and is used by the administrative console's search functions. Another two are located within close network proximity to the applications that host catalog services 132 to the e-commerce websites 134 and is used by those applications' search and query functions. The read only data store 106 used by the administrative console is a highly reliable, scalable and fault tolerant search engine that provides distributed indexing, replication and load-balanced querying, automated failover and recover, and centralized configuration. The format of the data is stored in it is usually variable length character strings which can be quickly and easily searched and accessed. Of the other two read only data stores, one is of the exact same type as the one used by the administrative console 106, another one is the exact same type as the event store 126. This data store 132 contains data that is usually searched and queried by dynamically changing conditions and used for real time dynamic computation.

Another set of message queues 128 hosted by the same type of messaging system, receive messages related to catalog data that may have too many permutations to be directly used by the e-commerce storefronts as their catalog content. These might include product prices (e.g. a product a price in each currency, locale, price list and site combination). A powerful cluster computing engine 138 for large-scale data processing is utilized in order to produce the large number of permutations of data quickly. These results are subsequently written into the read only data store 132 then used by the application that provides the catalog services to the e-commerce websites 136.

The cluster computing engine 138 is very powerful. It consolidates multiple tasks or operations into a single computational unit to increase compute resource utilization and reduce the costs and management overhead associated with performing computation processing in software applications.

Another cluster computing engine of the same type but located in a different physical location for data analytics (not shown) is utilized to get the data from the read only store (not shown) of the same type as the event store 126. Based on the large number of various dynamic conditions passed in externally that engine performs fast distributed computations to determine the best results in real time.

The catalog services that are invoked and used by the e-commerce websites are hosted by a dedicated software service application 136 that obtains some catalog content that has already been generated from the read only data store 132 due to precomputation and restructuring of catalog data from the central catalog database and content that was generated by the cluster computing engine 138 for real time dynamic computations. Real time dynamic computations may be based on various dynamic conditions that might be different throughout different time periods. The content of those two sources can be directly used by the e-commerce websites. This application's 136 role is a composer that combines and transforms the data returned by multiple services or APIs into one single meaningful data set either through a choreographer or an orchestrator. A choreographer is a form or method of service composition in which the interaction protocol between several partner services is defined from a global perspective, basically the coordinated interactions between multiple parties/services, and is a way of specifying how two or more parties—none of which has any control over the other parties' processes, or perhaps any visibility of those processes—can coordinate their activities and processes to share information and value. An orchestrator provides the automated execution of a workflow or business process that is being implemented by a central controller. This application follows a software architecture pattern that incorporates different methods of combining the execution or invocation of two or more non-sequential, interdependent or independent operations together either through orchestration or choreography and then aggregates pre-defined pieces of data to provide a meaningful business outcome in response to a query from the webstore.

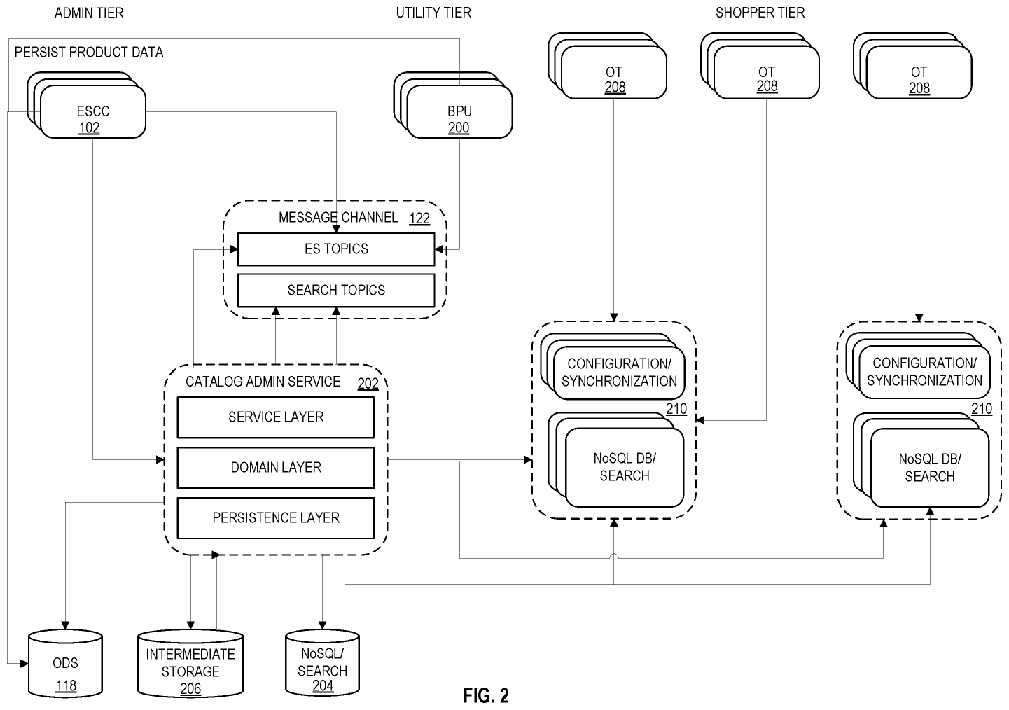

FIG. 2 further illustrates exemplary components and modules of a catalog product data management system that implements the techniques of this disclosure. The e-commerce system's 102 administrative console and bulk product upload tool 200 can create, edit and manage (for example, managing assignments of products to categories) products with their data in the central database which is the source of truth for all the product data 118. When those two applications perform the operations mentioned, they also notify a separate catalog admin application 202 with events (i.e. each event represents an activity or action with details such as who did it, what was done, where was it done, when was it done, optionally why was it done, and how was it done) asynchronously via a message queue 122. When the catalog admin application 202 receives those events, they are persisted into an event store (i.e. a database that stores a series immutable events) 126. Subsequently the catalog admin application 202 then notifies itself with an action message that corresponds to each event through the same message queue 122 used herein. Once it receives the action message from the same queue 122, then the corresponding affected product data is retrieved from the central database 118 and written into a data store that is of the same type as the event store 206 and as the intermediate storage for the product data. Subsequently, the same data is further processed by reformatting and restructuring it (i.e. de-normalization) then pushed into a powerful search engine 204 that is used by the application that hosts the catalog services for e-commerce websites. The status of the event that generated the action message is updated in the event store 206. The intermediate storage 206 is also used for delta detection and deduplication to remove unnecessary data pushes into the search engine 204. The search engine 204 by then has the newest product data in very simple format that can be easily searched and queried, easily transportable by web service and directly usable by websites as catalog content that is presented on web pages. As some websites and their order taker (copies of the central database 118) infrastructure 208 are located in different network topology, the catalog services application that provides catalog content has to be in close physical proximity and therefore the same type of search engine 210 is located in that same network topology and data center as the catalog services application 202. The catalog admin service 202 must be aware of that and push the product data into multiple search engines 204, 210. Ultimately the catalog admin service 202 is responsible for the administration and management of catalogs in those search engines to ensure their product data consistency, reliability, integrity, interoperability, usability and availability.

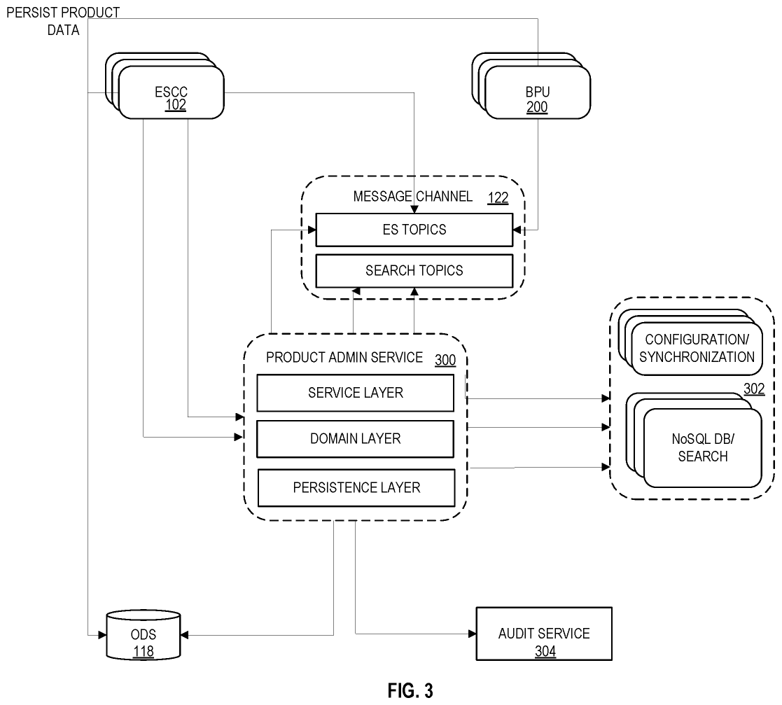

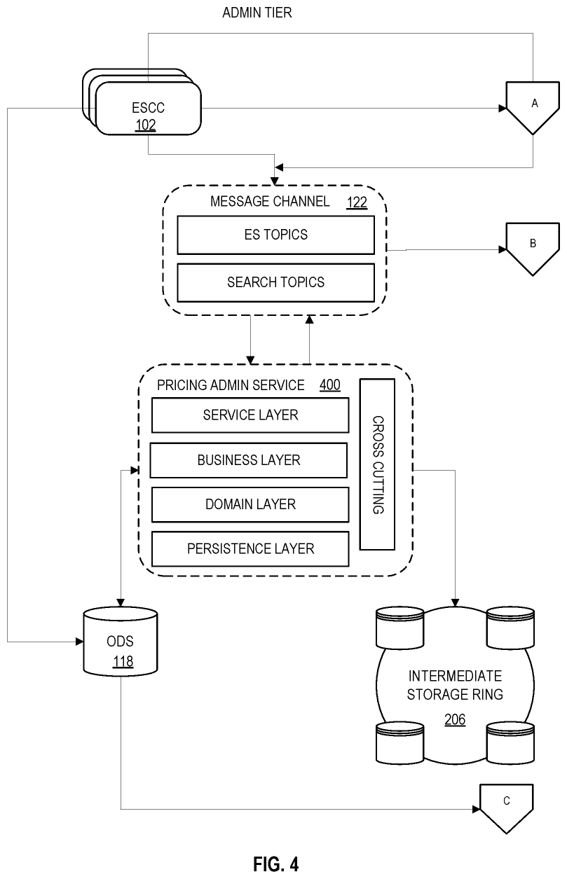

FIG. 3 basically illustrates the same things and data flows as FIG. 1 and FIG. 2, except in this exemplary system, the administrative console needs to perform very complex product search operations. The central database 118 stores complex product data that is not easily searchable if the search conditions contain many product standards and custom and variation defining attributes, therefore the product data is reformatted and restructured in the same manner as in FIGS. 4, 5 and 6 for pricing, below, via a catalog admin service into a search engine which provides search capabilities as web services that are dedicated for the administrative console only. This allows the administrators such as the catalog managers to search for complex products and their variations via various attributes.

Referring again to FIG. 3, several use cases are illustrated in this figure. In a migration use case, the administrator 102 updates product information and the ESCC sends a migration request to the ESCC Product Administration Service (PAS) 300. The administration service creates or reloads a collection of attributes and pushes all products to the NoSQL database and search engine 302 to be available for website queries. In addition, the ODS 118 performs a full import query to import the product updates into the source of truth database. A live update use case publishes data updates from either the BPU or the ESCC 102 to an appropriate channel in the message queueing system 122. The PAS 300, which subscribes to the channel to retrieve the messages and also publishes the messages back to the channel 122 as was described above. The PAS again pushes data to the NoSQL database and search engine 302. An audit history maintained in the PAS is pushed to the Audit Service 304. Finally, a query/search use case involves pushing data to the NoSQL database and search engine 302 for website availability.

FIGS. 4, 5 and 6 further illustrates exemplary components and modules of a catalog product pricing management system that is similar to FIG. 3 except for two major technical differences due to the nature of the pricing data. A product can have many prices, because an e-commerce site has many price lists, currencies and locales; a product can be sold on multiple sites and can be in multiple catalogs, so a product can have a price in each currency, locale, price list, site and catalog combination, and there can be many different combinations. A product may have many variations and those variations can either inherit the prices defined on their base product or overwrite them. A product price is determined on the e-commerce storefront with those conditions, however with the data model in the central database that real time pricing determination is inefficient but the determination conditions for most products displayed on the e-commerce sites are the same most of the time, so most of the storefront price look up operations query against the same data (i.e. static prices). When displaying a product price in a product details page, product category page or search result page on the storefront, all prices on the price list are queried, then computation is performed to determine which price's attributes match the storefront attributes (e.g. currency, locale, catalog), even those prices are rarely changed, so the performance of storefront may not be good if it needs to load a list of product prices, because of real-time computation. The problem is magnified when the storefront needs to sort product by price and do pagination because a large number of price computations are performed. Since the prices on the price lists don't have too many attributes, the price list prices can be stored in a manner with those attributes as look up keys, so if the storefront attributes match those keys the correct product price is directly obtained without performing any calculation or computation.

A major technical difference between product and pricing systems is that the prices are pre-calculated via a powerful distributed cluster computing engine in order for a large number of permutations of pricing data to be produced quickly. The data format and structure of these results are the same as the de-normalized product data in the search engine illustrated in FIG. 1. All the static prices are subsequently written into the same search engine by the same computing engine that did the pre-calculations. Another major technical difference is that the pricing admin service sends the raw data to the cluster computing engine via the message queue for pre-computations.

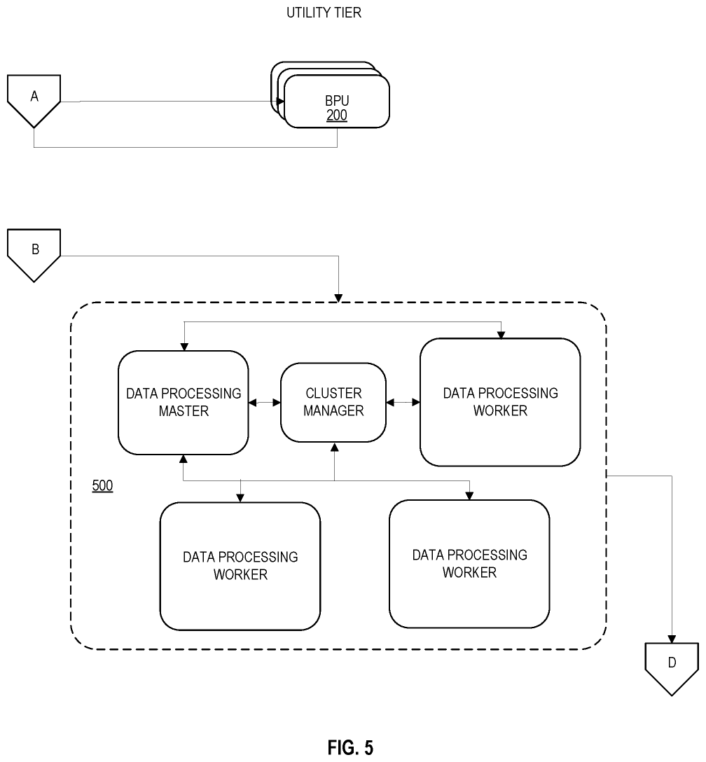

FIG. 4 illustrates the Admin Tier of the Pricing Administrative Service (PrAS) 400. ESCC 100 sends the full and delta import messages via the message channel 122, which are subscribed to by the PrAS 400. The PrAS 400 receives delta and full import messages from ESCC 100 via the message channel. The messages are processed through the service and business layers, the domain layer and the persistence layer. Pricing updates are extracted by PrAS 400 and imported into the ODS 118. Further, PrAS 400 writes the retrieved pricing information from the ODS 118 into the intermediate storage 206 for delta detection and de-duplication to be used later for pre-calculations. Delta detection and de-duplication minimize redundant pre-calculations and writes to the NoSQL/Search database 210. Price calculation messages are published to the message channel 122. Referring now to FIG. 5, which is an extension of FIG. 4, illustrates the utility tier and pricing updates made through bulk pricing uploads 200 and transmittal of full and delta import messages to a message channel 122 (A). Also included in this illustration is the receipt of message data 122 (B) from the message channel at a static price pre-calculation and conversion service 500, a distributed cluster computing engine. This process retrieves price calculation messages from the message channel and performs static price pre-calculations in parallel based on the data in the messages. The pre-calculated results are written to the NoSQL database/search engine 210 (D). The static price pre-calculation and conversion service 500 is comprised of a data processing cluster in order to provide sufficient computing power.

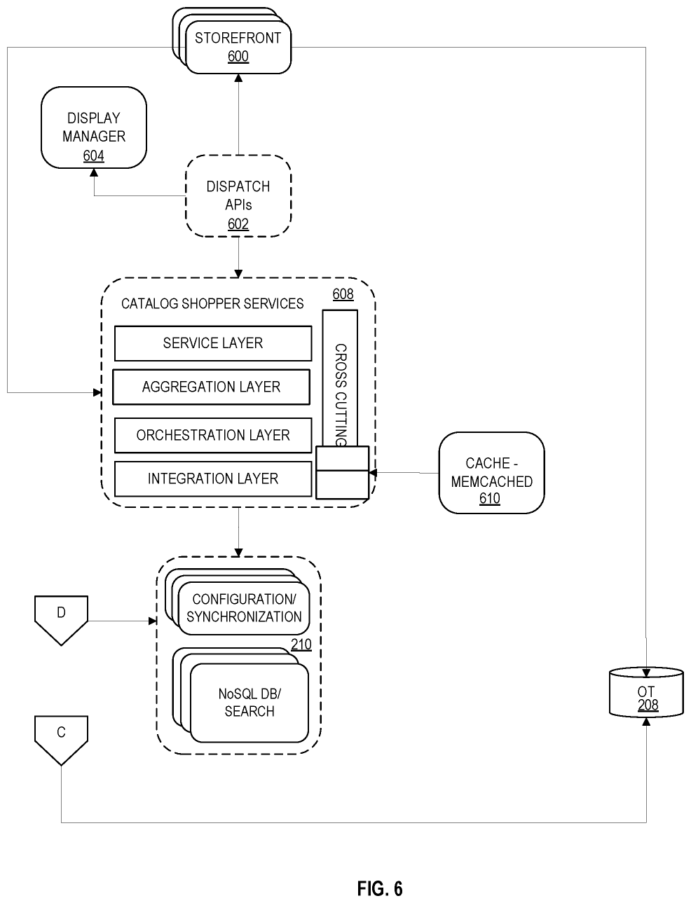

FIG. 6 is an extension of FIG. 5 which illustrates the shopper, or storefront 600 presentation, tier. As was discussed above, pre-calculation results are written to the NoSQL database/search engine 210 (D). A storefront pricing tag can obtain static list price stored in the NoSQL database 210 via the catalog shopper service 608 which is an abstraction. The Storefront or display manager 604 obtains static list prices stored in the NoSQL database through a Dispatch service (API service) 602 via the catalog shopper service 608. The catalog shopper service performs some aggregation or orchestration by getting different pieces of static data (e.g. static price, daily conversion rates, product data) from the NoSQL database/search engine 210. The result of this system and method is the quick and efficient display to the shopper 600 of accurate and relevant pricing information.

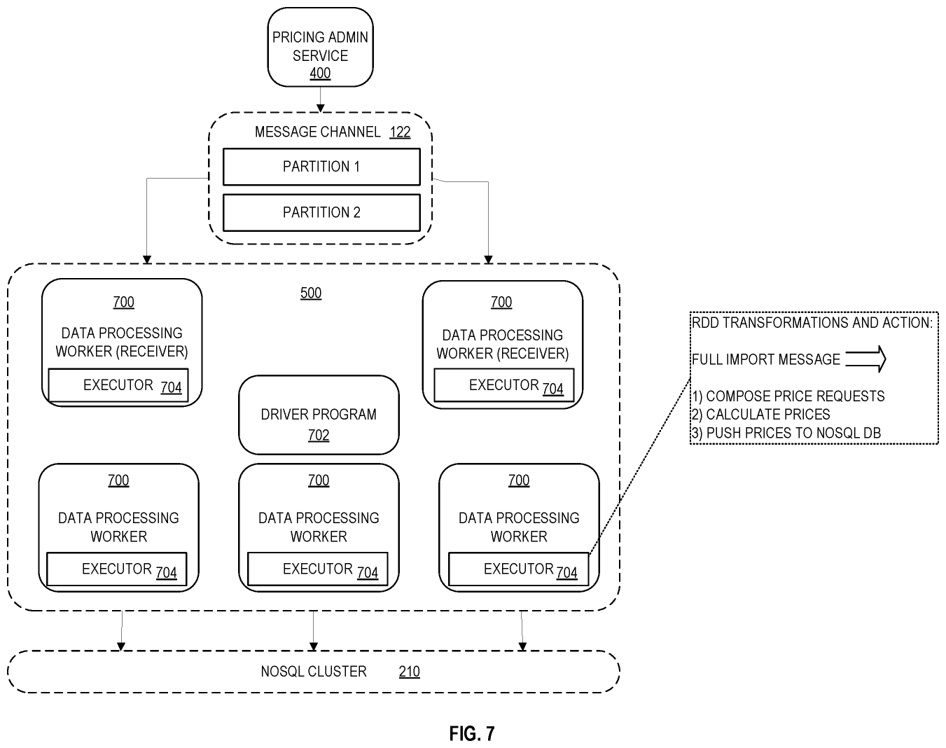

FIG. 7 illustrates the two major technical differences mentioned in above in greater detail. The PrAS 400 publishes the price calculation messages to the queue 122, the receiver workers in the distributed cluster computing engine 500 regularly pull the message from the queue 122 periodically. The multiple streams of messages are automatically merged into one stream, those messages are then repartitioned 122 and sent to core workers 700 to pre-calculate the prices simultaneously, once the prices are calculated, they will be pushed to the NoSQL database/search engine 210. Within the cluster there is a driver program 702 that creates the cluster environmental context and sends tasks to the executors 704 to run. Each worker 700 runs their own executor 704 that keeps and processes the received data with tasks in memory. There are two types of tasks that are assigned to the executors 704, receiving the messages and pre-calculating the prices. The workers 700 for pre-calculating prices will first compose the price requests (i.e. map the incoming messages into the list of price look up requests for each product, currency, locale, price list, site and catalog combination), and for each request will calculate the prices and map them into a result set, then finally for each partition 122 of calculated price results, push the data into the search engine 210 by batches.

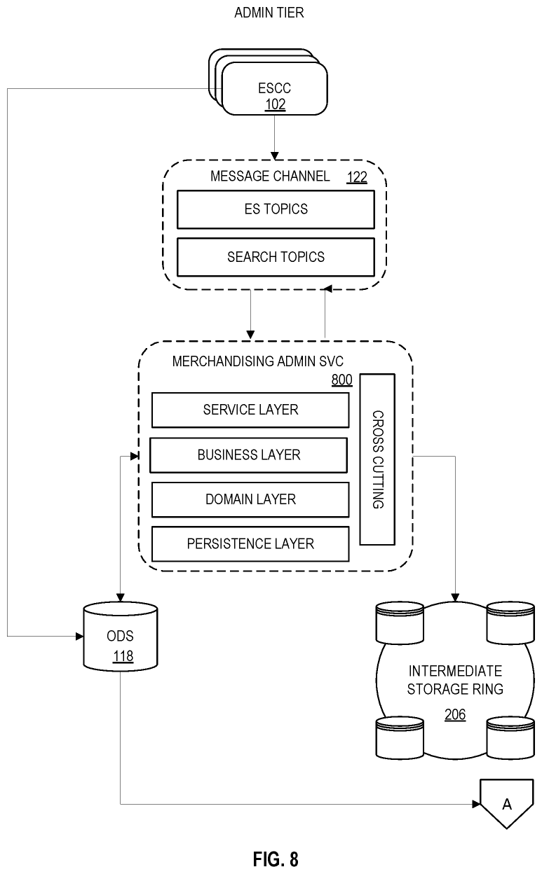

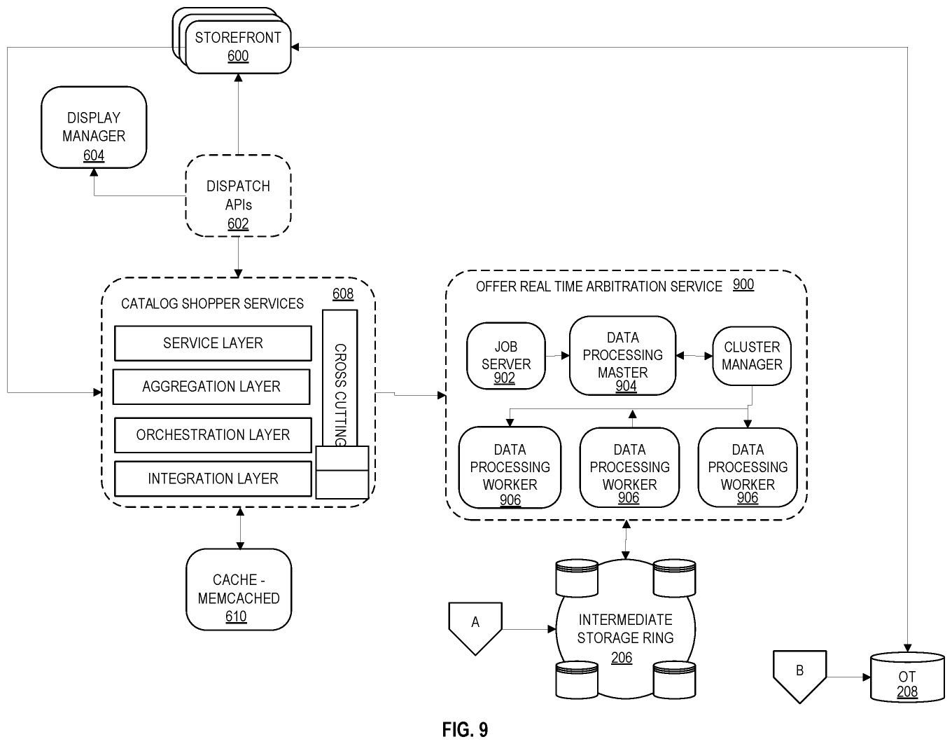

FIGS. 8 and 9 illustrate exemplary components and modules of a catalog merchandising management system that is similar to the pricing management system in FIGS. 4, 5 and 6 except with two major technical differences due to the nature of the merchandising discount type offers and their offer instances (i.e. business objects that contain the details of a specific merchandising offer that is applicable to only a shopper or to all the shoppers on a specific storefront). Since a discount type offer can be applied to one-to-many products, a product can be associated/tied to one-to-many discount offers. Each discount offer has many settings such as, but not limited to, discount options (amount, amount off, percent off), start time, end time (down to the level of a minute), offer usage limits (total limit, coupon limit, shopper limit), product eligibility (applies to specific products or specific categories), locale restriction, currency, and exclusions (excludes specific products or excludes specific categories). These represent the dynamic conditions on the e-commerce storefronts in order to determine the best discount available to a product with the static price from the process described in FIGS. 4, 5 and 6.

The offer instances are reformatted and restructured by the merchandising admin service and stored in the database that also contains the event store. The data in the physical storage that is created and updated by the merchandising admin service will automatically synchronize to another instance of the same type of storage that is physically located in a different network topology which belongs to a different data center collocated with the merchandising shopper service to provide products' best discount.

A powerful cluster computing engine for data analytics is located in the close network proximity of the application that hosts the catalog services to be used with the e-commerce websites. That engine is used to perform very fast, real-time distributed computation in order to arbitrate the best discount offer instance among many offer instances in the data storage mentioned herein for a product or for many products based on the dynamic conditions mentioned above in one single request.

FIG. 8 illustrates the Admin Tier with a Merchandising Administrative Service 800. Updates to merchandising generally come from the ESCC 100 administrator interface. As is illustrated in FIG. 8, the ESCC 100 sends full and delta import messages via the message channel 122 to the MAS 800 which writes offer instances into intermediate storage. The MAS 800 receives delta and full import messages that represent newly created and updated offer instances from the ESCC. The MAS 800 retrieves offer instances and relevant data to be written into intermediate storage 206 from the ODS 118. MAS writes the retrieved offer instances and relevant data from ODS into intermediate storage, which may be synchronized with other intermediate storage rings and nodes 206 and will later be used for real-time arbitrations. The offer instances and relevant merchandising data are synchronized into the intermediate storage shopper ring in the shopper tier (A). Referring now to FIG. 9, a storefront pricing tag can obtain the best arbitrated offer instance through Dispatch 602 via a Catalog Shopper Service (CSS) 608 API, which checks a CAS cache 610 for the requested data. If the data requested in not found in the cache 610 the CAS sends a request to the cluster job server 900 hosting an Offer Real-Time Arbitration Service 900 to perform arbitrations in parallel. The arbitration service nodes 902 read merchandising offer instances and relevant data from intermediate storage 206 and perform arbitrations in parallel based on all the merchandising data.

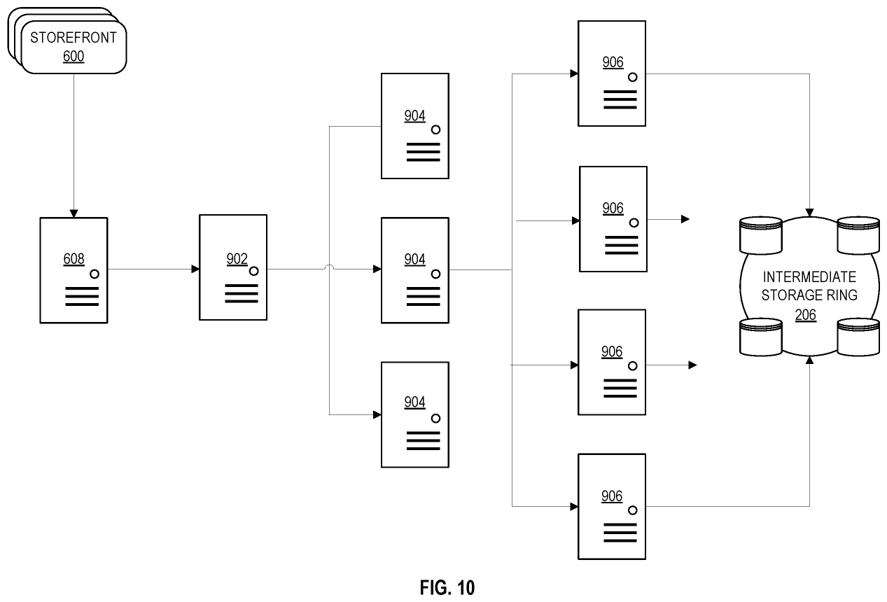

FIG. 10 illustrates how the best discount offer instance can be obtained for a product that is displayed on the storefront 600 through the CSS 608. This is very similar to the process described in FIG. 7 where one or more requests can contain a set of parameters with their value, or many sets of values. Value sets may be comprised of product ID, product price, currency, locale, category ID, catalog ID and site ID. The job server 902 application is a web service facade that takes the requests, passes them to the master application 904, which splits the requests and distributes them to different workers 906. The workers process the assigned requests with fast random row access into the database 206 to determine the result. The master application does the same for requests with many sets of parameters with their values. The workers 906 process the assigned sets to determine their best result and return all the results to the master application 904, which in turn returns to an invoker through the job server application 902.

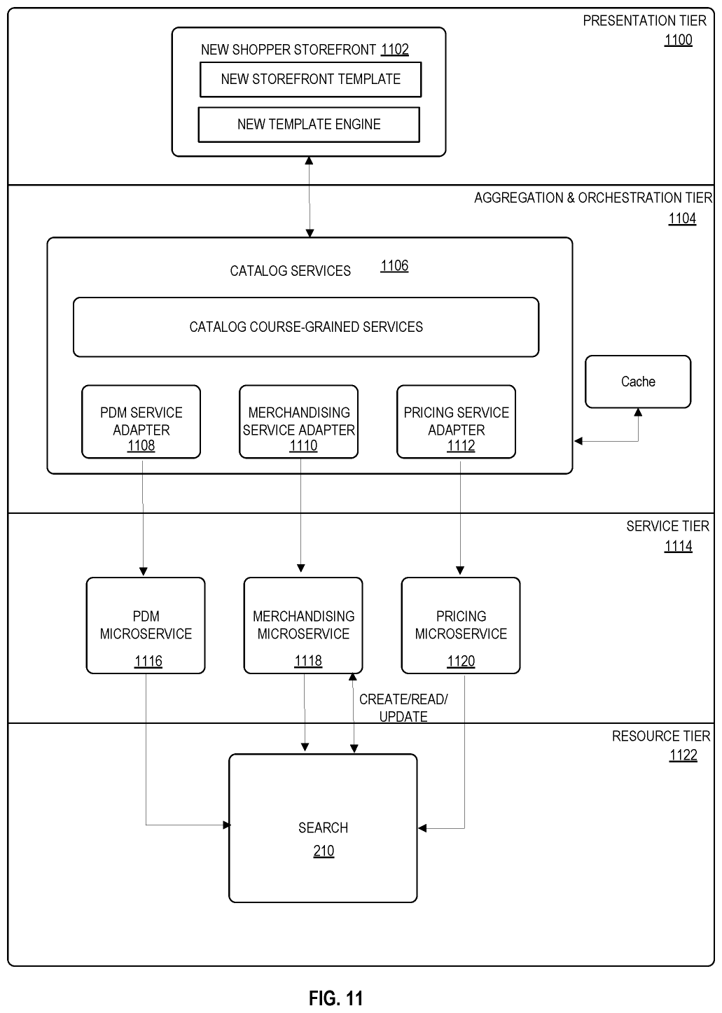

FIG. 11 illustrates the modules and components of the catalog domain aggregation service as a coarse-grained service (a software service that exposes the invocation of a single, discrete business process or workflow), with a presentation tier 1100, an aggregation and orchestration tier 1102, a service tier 1104 and a resource tier. The presentation tier 1100 includes the storefront 600 with new storefront template and new template engine components. The aggregation and orchestration tier 1102 is comprised of service adaptors for product management, merchandising and pricing services and cache. The technique that is used the aggregate the response from the product data service, the response from product pricing service, and the response from the product best discount service into one single response is called orchestration. Results from each service are aggregated together then returned by web service to the e-commerce storefronts. A cache is also utilized to store the final response payloads with a time to live period for the storefronts, so the aggregation service does not need to repeatedly call out to the catalog micro-services for the same data which can incur network overhead. The service tier 1104 is comprised of microservices for each service. These are software applications as independent deployable fine-grained services that are easily modifiable, interoperable, testable and scalable. The resource tier is comprised of the NoSQL database/search engine 210 which allows all services to search and query denormalized data for presentation to the end user. Upon presentation to the end user, the end user may select a product for order fulfillment.

The many features and advantages of the present disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

The individual components of the disclosed system and method are necessarily composed of a number of electronic components. Ecommerce systems are hosted on servers that are accessed by networked (e.g. internet) users through a web browser on a remote computing device. One of ordinary skill in the art will recognize that a “host” is a computer system that is accessed by a user, usually over cable or phone lines, while the user is working at a remote location. The system that contains the data is the host, while the computer at which the user sits is the remote computer. Software modules may be referred to as being “hosted” by a server. In other words, the modules are stored in memory for execution by a processor. The ecommerce application generally comprises application programming interfaces, a commerce engine, services, third party services and solutions and merchant and partner integrations. The application programming interfaces may include tools that are presented to a user for use in implementing and administering online stores and their functions, including, but not limited to, store building and set up, merchandising and product catalog (user is a store administrator or online merchant), or for purchasing items from an online store (user is a shopper). For example, end users may access the ecommerce system from a computer workstation or server, a desktop or laptop computer, a mobile device, or other electronic telecommunications or computing device. A commerce engine comprises a number of components required for online shopping, for example, customer accounts, orders, catalog, merchandizing, subscriptions, tax, payments, fraud, administration and reporting, credit processing, inventory and fulfillment. Services support the commerce engine and comprise one or more of the following: fraud, payments, and enterprise foundation services (social stream, wishlist, saved cart, entity, security, throttle and more). Third party services and solutions may be contracted with to provide specific services, such as address validation, payment providers, tax and financials. Merchant integrations may be comprised of merchant external systems (customer relationship management, financials, etc), sales feeds and reports and catalog and product feeds. Partner integrations may include fulfillment partners, merchant fulfillment systems, and warehouse and logistics providers. Any or all of these components may be used to support the various features of the disclosed system and method.

An electronic computing or telecommunications device, such as a laptop, tablet computer, smartphone, or other mobile computing device typically includes, among other things, a processor (central processing unit, or CPU), memory, a graphics chip, a secondary storage device, input and output devices, and possibly a display device, all of which may be interconnected using a system bus. Input and output may be manually performed on sub-components of the computer or device system such as a keyboard or disk drive, but may also be electronic communications between devices connected by a network, such as a wide area network (e.g. the Internet) or a local area network. The memory may include random access memory (RAM) or similar types of memory. Software applications, stored in the memory or secondary storage for execution by a processor are operatively configured to perform the operations in one embodiment of the system. The software applications may correspond with a single module or any number of modules. Modules of a computer system may be made from hardware, software, or a combination of the two. Generally, software modules are program code or instructions for controlling a computer processor to perform a particular method to implement the features or operations of the system. The modules may also be implemented using program products or a combination of software and specialized hardware components. In addition, the modules may be executed on multiple processors for processing a large number of transactions, if necessary or desired. Where performance is impacted, additional processing power may be provisioned quickly to support computing needs.

A secondary storage device may include a hard disk drive, floppy disk drive, CD-ROM drive, DVD-ROM drive, or other types of non-volatile data storage, and may correspond with the various equipment and modules shown in the figures. The secondary device could also be in the cloud. The processor may execute the software applications or programs either stored in memory or secondary storage or received from the Internet or other network. The input device may include any device for entering information into computer, such as a keyboard, joy-stick, cursor-control device, or touch-screen. The display device may include any type of device for presenting visual information such as, for example, a PC computer monitor, a laptop screen, a phone screen interface or flat-screen display. The output device may include any type of device for presenting a hard copy of information, such as a printer, and other types of output devices include speakers or any device for providing information in audio form.

Although the telecommunications device, computer, computing device or server has been described with various components, it should be noted that such a telecommunications device, computer, computing device or server can contain additional or different components and configurations. In addition, although aspects of an implementation consistent with the system disclosed are described as being stored in memory, these aspects can also be stored on or read from other types of computer program products or computer-readable media, such as secondary storage devices, including hard disks, floppy disks, or CD-ROM; a non-transitory carrier wave from the Internet or other network; or other forms of RAM or ROM. Furthermore, it should be recognized that computational resources can be distributed, and computing devices can be merchant or server computers. Merchant computers and devices (e.g.) are those used by end users to access information from a server over a network, such as the Internet. These devices can be a desktop PC or laptop computer, a standalone desktop, smart phone, smart TV, or any other type of computing device. Servers are understood to be those computing devices that provide services to other machines, and can be (but are not required to be) dedicated to hosting applications or content to be accessed by any number of merchant computers. Web servers, application servers and data storage servers may be hosted on the same or different machines. They may be located together or be distributed across locations. Operations may be performed from a single computing device or distributed across geographically or logically diverse locations.

Client computers, computing devices and telecommunications devices access features of the system described herein using Web Services and APIs. Web services are self-contained, modular business applications that have open, Internet-oriented, standards-based interfaces. According to W3C, the World Wide Web Consortium, a web service is a software system “designed to support interoperable machine-to-machine interaction over a network. It has an interface described in a machine-processable format (specifically web service definition language or WSDL). Other systems interact with the web service in a manner prescribed by its description using Simple Object Access Protocol (SOAP) messages, typically conveyed using hypertext transfer protocol (HTTP) or hypertext transfer protocol secure (HTTPS) with an Extensible Markup Language (XML) serialization in conjunction with other web-related standards.” Web services are similar to components that can be integrated into more complex distributed applications.

The applications discussed herein may be home-grown applications, however, one skilled in the art may be familiar with existing commercial applications, often open source applications, that are available to function as many of the components. For example, Kafka® is a high-throughput distributed messaging system that provides all the functional and non-functional capabilities of a message queue 122. Spring Cloud is a set of tools supporting distributed systems which contains and manages software applications as micro-services through service registration and discovery, data routing, service to service calls, and load balancing and is highly suitable for use as an event service and denormalizer component 124.

Cassandra™ is an open source distributed database management system designed to handle large amounts of data across many commodity servers, providing high availability with no single point of failure. Cassandra offers robust support for clusters spanning multiple datacenters, with asynchronous master less replication allowing low latency operations for all clients. data model is a partitioned row store with tunable consistency. Rows are organized into tables, the first component of a table's primary key is the partition key, within a partition, rows are clustered by the remaining columns of the key. Other columns may be indexed separately from the primary key. Tables may be created, dropped, and altered at runtime without blocking updates and queries. Cassandra is highly suitable for use as the intermediate data storage component 206.

Apache SolrCloud is an open source enterprise search platform utilizing a NoSQL database. SolrCloud is highly reliable, scalable and fault tolerant and highly suited for use as the NoSQL database and search engine 210. It provides distributed indexing, replication and load-balanced querying, automated failover and recover, and centralized configuration. ReactiveX is an API for asynchronous programming with observable streams, basically a library for composing asynchronous and event-based programs using observable sequences. ReactiveX may be used in many of these embodiments. Other features may utilize technologies such as JSON, REST, JDI/JDBC, Java and others to communicate between components and modules.

Spark (Apache Spark™) is a fast and general open source cluster computing engine for large-scale data processing, which consolidates multiple tasks or operations into a single computational unit to increase compute resource utilization and reduce the costs and management overhead associated with performing compute processing software applications. Spark is ideally suited for use as the denormalization computation engine 130, the real-time Static Price Pre-Calculation Conversion service 500, and the Offer Real-Time Arbitration Service 900.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application, while maintaining substantially the same functionality without departing from the scope and spirit of the present invention.

What is claimed is:

1. A distributed computing system for asynchronously generating catalog data from complex catalogs in a simple format and structure, the system comprising:
a computing device including a processor and a memory; and
a software module stored in the memory, comprising executable instructions that when executed by the processor cause the processor to:
decipher complex product data from the e-commerce system's central database; reformat and restructure all that data as copies of original data;
write the reformatted and restructured product data into an intermediate data storage;
copy the product data from an intermediate data storage into a search engine wherein intermediate data storage may be used as an event store to record he series of events for future auditing and he product data is stored for delta detection and duplication to minimize unnecessary copying of data into the search engine providing query and search capabilities as web services to retrieve product data over the Internet; and a service application handing product data related business logic and rules to access the search engine to get the appropriate product data for presentation on online storefronts.

2. A computer implemented method for asynchronously generating product's prices in a simple format and structure directly usable by websites, with each price matching certain e-commerce storefront shopping conditions, the method comprising:
Deciphering, by a processor, complex product prices and price lists with their inheritance relationships from the e-commerce system's central database;
Reformatting and restructuring, by a processor, all the data as copies of original data.
Writing, by a processor, the reformatted and restructured product prices into an intermediate data storage, the intermediate data storage also an event store recording the series of events for auditing purposes and the product prices are stored in the intermediate storage for delta detection and deduplication to minimize further unnecessary operations;
Distributing, by a processor, pre-calculation of a large number of raw product prices among many computational units in parallel to quickly get each result of a combination of certain storefront shopping conditions and writing the results into a search engine; and
Querying, by a processor, the search engine as web services to retrieve product prices matching certain e-commerce storefront shopping conditions input by a user operating on an online storefront.

3. A computer implemented method for asynchronously generating merchandising discount offer instances in a simple format and structure that can be analyzed by real time multi-dimensional filtering and grouping to determine the best discount offer instance to be applied to a product based on many dynamic storefront shopping conditions at different points in time, the method comprising:
Deciphering, by a processor, complex discount offers with their primary and secondary instances from the e-commerce system's central database;
Reformatting, by a processor and restructuring all that data as copies of original data.
Writing, by a processor, the reformatted and restructured discount offers with their primary and secondary instances into an intermediate data storage, the intermediate data synchronizing the data that has been written to it to another same type of data storage that is physically located in close network proximity as the catalog applications for deriving product's best discount.
Distributing, by a processor, located in close network proximity as the catalog application that hosts the catalog services for e-commerce websites, distributing real time arbitrations of large number of raw discount offer instances among many computational units in parallel to quickly to get the result for a given combination of multiple storefront shopping conditions at a point in time;
Accessing, by a processor operatively connected to a powerful distributed computational engine to, a service application comprising product related discount business logic and rules to get product prices with their best discount and discounting information for presentation on online storefronts.

4. A distributed computing system providing product attributes, pricing and merchandising of products in a request, the system comprising:
An orchestration engine with memory and processor and a software module stored in memory with executable instructions that when executed by the processor cause the processor to invoke a product data web service API hosted by a product data service application and a product price web service API hosted by the product pricing service application concurrently in parallel, invoking the product best discount web service API hosted by a product discounting service application.
An aggregation engine with memory and processor and a software module stored in memory with executable instructions that when executed by the processor cause the processor to combine the results from multiple web service invocations together into one single payload, such payload stored into a cache with a time to live.
The service facade hosting coarse-grained catalog services, each service with memory and processor and a software module stored in memory with executable instructions that when executed by the processor cause the processor to invoke a set of application programming interfaces of these services when called by another client, whereby the client is an e-commerce website or web application, and accessing the cache to get the response payload based on the request parameter with the value or values of the request parameter as the composite key and, if not finding the response payload, accessing the aggregation engine to get the response payload.
